(19) United States
(12) Patent Application Publication
(10) Pub. No.: US 2011/0176077 A1
(43) Pub. Date: Jul. 21, 2011

(54) DRIVING METHODS FOR CHOLESTERIC LIQUID CRYSTAL DISPLAY DEVICES

(75) Inventors: DA-WEI LEE, Taoyuan County (TW); Yi-An Sha, Taipei City (TW); Jyh-Wen Shiu, Hsinchu County (TW)

(73) Assignee: INDUSTRIAL TECHNOLOGY RESEARCH INSTITUTE, HSINCHU (TW)

(21) Appl. No.: 13/077,450

(22) Filed: Mar. 31, 2011

Related U.S. Application Data
(62) Division of application No. 11/942,678, filed on Nov. 19, 2007.

(30) Foreign Application Priority Data
Nov. 24, 2006 (TW) TW95143530

(51) Int. Cl. G02F 1/133

(52) U.S. Cl. 349/33

(57) ABSTRACT

Driving methods for cholesteric liquid crystal display devices are provided. The driving method includes providing a cholesteric liquid crystal display, wherein the capacitance detector corresponds to a driving module; outputting a capacitance sensing voltage waveform from the driving module to the cholesteric liquid crystal display panel such that a capacitance value of the cholesteric liquid crystal layer is acquired and stored in the memory; and when the capacitance value falls in a capacitance range of a second displaying state, the capacitance detector outputs a second sensing result, and when the capacitance value falls in a capacitance range of a first displaying state, the capacitance detector outputs a first sensing result.

### CROSS REFERENCE TO RELATED APPLICATIONS

This application is a Divisional of pending U.S. patent application Ser. No. 11/942,678, filed Nov. 19, 2007 and entitled “Cholesteric liquid crystal display devices and driving methods thereof”, which claims priority of Taiwan Patent Application No. 95143530, filed on Nov. 24, 2006, the entirety of which is incorporated by reference herein.

### BACKGROUND OF THE INVENTION

1. Field of the Invention

The invention relates to liquid crystal display (LCD) devices, and in particular to cholesteric liquid crystal display devices and driving methods thereof.

2. Description of the Related Art

Liquid crystal display (LCD) devices have many advantages such as small volume, light weight and low power consumption, and are applicable in a variety of electronic and communication devices including notebook computers, personal digital assistants (PDA), mobile phones and the like due to its lighter weight, thinner profile, and portability.

Conventional liquid crystal displays integrated with touch panels are typically applied in notebooks or personal computers, and particularly to personal assistants (PDA). Some liquid crystal display devices are integrated with a position sensing touch panel. When a stylus touches the liquid crystal display device and makes contact, the position sensing touch panel detects the position of the stylus, thereby displaying on the liquid crystal display device.

For example, a conventional touch-sensitive liquid crystal display device comprises an electrical resistive touch panel and a stylus. When the stylus directly contacts the touch panel, location of the stylus on the touch panel is detected according to resistance change of the circuit in the electrical resistive touch panel.

Typically, a touch-sensitive liquid crystal display device integrates a touch panel on a liquid crystal display (LCD) panel as a single input type liquid crystal display device. The touch panel is configured between the viewer and the liquid crystal display (LCD) panel to facilitate hand-writing input. Incident light passing through the touch panel, however, may cause reflection, resulting in a glaring light for the viewer and a detrimental image contrast ratio for the LCD panel.

In order to solve the glaring light problem and deteriorating image contrast ratio for the LCD panel, U.S. Pat. No. 6,982,432, the entirety of which is hereby incorporated by reference discloses a touch-sensitive liquid crystal display device including a combination of a tough panel and an LCD panel in which the LCD panel is configured between the viewer and the touch panel to facilitate hand-writing input.

FIG. 1 is a cross section of a conventional touch-sensitive liquid crystal display device. Referring to FIG. 1, a conventional touch-sensitive liquid crystal display device includes a touch panel 4 and an LCD panel 3A in which the LCD panel 3A is configured between the viewer and the touch panel 4. The LCD panel 3A includes a color filter substrate 31 with an electrode layer 32 thereon and a transparent substrate 35 with a transparent electrode layer thereon. A micro-molecule dispersed liquid crystal layer 33 is interposed and enclosed by a sealer 33 between the color filter substrate 31 and the transparent substrate 36.

The touch panel 4 include an electrode 41 disposed on the transparent substrate 36 and an electrode 43 disposed on the substrate 44. The electrode 41 and the electrode 43 are separated by a gap. The transparent substrate 36 and the substrate 44 are sealed by a sealer 42. The hand-writing input and image displaying are respectively achieved via the touch panel 4 and the LCD panel 3A. The touch-sensitive liquid crystal display device comprises at least two layers of independent panel structures. The entire structure and fabrication process is complex, resulting in high production cost.

Furthermore, at the IDW annual conference, 2004, Fuji Xerox discloses a photo input type touch-sensitive liquid crystal display device. Hand-writing data are input from the back of an LCD panel by a photo-input device. Additional light sources, however, are necessary to render hand-writing data, which is difficult to operate. Moreover, the photo-input device requires collaborating a photo detect layer in the touch-sensitive liquid crystal display device, resulting in structural complexity and high fabrication costs. Conversely, another photo input type touch-sensitive liquid crystal display device can input hand-writing data from the front of a LCD panel by a photo-input device. Thus, the photo detect layer is unnecessary. However, with the additional light sources as the input means, the touch-sensitive liquid crystal display device is still difficult to operate.

### BRIEF SUMMARY OF THE INVENTION

A detailed description is given in the following embodiments with reference to the accompanying drawings.

A cholesteric liquid crystal display (Ch-LCD) device is provided using pressure to modulate orientations of cholesteric liquid crystal molecules. Since the orientations of cholesteric liquid crystal molecules, which depend on capacitance and reflection of the Ch-LCD device, provide dual-stable states of the Ch-LCD device, the Ch-LCD device can exhibit dual mode function of displaying and/or inputting data image.

Exemplary embodiments of the invention provide a cholesteric liquid crystal display device, comprising: a cholesteric liquid crystal display panel comprising a first substrate, a second substrate and a cholesteric liquid crystal layer interposed therebetween, wherein the cholesteric liquid crystal includes at least a first displaying state and a second displaying state; and a capacitance detector measuring the displaying state of the cholesteric liquid crystal layer, stored as a first output signal or second output signal in a memory.

Exemplary embodiments of the invention further provide a cholesteric liquid crystal display device, comprising: a cholesteric liquid crystal display panel having a plurality of regions, with each region comprising a first substrate, a second substrate and a cholesteric liquid crystal layer interposed therebetween, wherein the cholesteric liquid crystal includes at least a first displaying state and a second displaying state; and a capacitance detector measuring the displaying state of each region of the cholesteric liquid crystal layer, stored as a first output signal or second output signal in a memory.

Exemplary embodiments of the invention further provide a cholesteric liquid crystal display device, comprising: a cholesteric liquid crystal display panel having a plurality of regions, with each region comprising a first substrate, a second substrate and a cholesteric liquid crystal layer interposed therebetween, wherein the cholesteric liquid crystal includes at least a first displaying state and a second displaying state; a driving module rendering each region of the cholesteric liquid crystal display panel to display a first displaying state and a second displaying state; and a capacitance detector measuring the displaying state of each region of the cholesteric liquid crystal layer, stored as a first output signal or second output signal in a memory.

Exemplary embodiments of the invention further provide a driving method for a cholesteric liquid crystal display device, comprising: providing a cholesteric liquid crystal display device, wherein the capacitance detector corresponds to a driving module; outputting a capacitance sensing voltage waveform from the driving module to the cholesteric liquid crystal display panel such that a capacitance value of the cholesteric liquid crystal layer is acquired and stored in the memory; and when the capacitance value falls in a capacitance range of a planar texture state, the capacitance detector outputs a second sensing result, and when the capacitance value falls in a capacitance range of a the focal conic texture state, the capacitance detector outputs a first sensing result.

Exemplary embodiments of the invention provide a driving method for a cholesteric liquid crystal display device, comprising: providing a cholesteric liquid crystal display device, wherein the capacitance detector corresponds to a driving module, and wherein the driving module outputs a capacitance sensing voltage waveform to a first region of the cholesteric liquid crystal display panel such that a first capacitance value corresponding to the first region of the cholesteric liquid crystal layer is acquired and stored in the memory; outputting a first voltage waveform from the driving module to the first region rendering displaying of a first displaying state; outputting a capacitance sensing voltage waveform from the driving module to the first region such that the capacitance detector detects a second capacitance value from the first region which is stored in the memory; if the first capacitance value equals the second capacitance value, the first region displays the first displaying state initially, and the capacitance detector outputs a first sensing result which is stored in the memory; and if the first capacitance value is different from the second capacitance value, the first region displays the second displaying state initially, and the capacitance detector outputs a second sensing result which is stored in the memory, and a second voltage waveform is outputted from the driving module to the first region, thereby rendering the original second displaying state on the first region.

### BRIEF DESCRIPTION OF THE DRAWINGS

The invention can be more fully understood by reading the subsequent detailed description and examples with references made to the accompanying drawings, wherein:

FIG. 1 is a cross section of a conventional touch-sensitive liquid crystal display device;

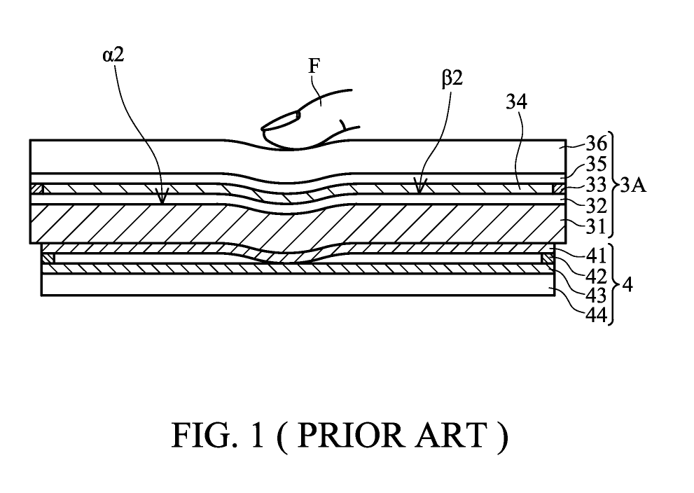

FIG. 2 is a cross section of an exemplary embodiment of the Ch-LCD device;

FIG. 3A and FIG. 3B respectively show a planar texture state and a focal conic texture state of the orientations of the cholesteric liquid crystal molecules;

FIG. 4 shows the transformational relationship between a planar texture state and a focal conic texture state following an applied field to the Ch-LCD panel;

FIG. 5A and FIG. 5B are respectively schematic views illustrating measurement of the capacitances of the planar texture state and the focal conic texture state of the Ch-LCD device; and

FIG. 6 is a block diagram of an exemplary embodiment of the Ch-LCD device.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Exemplary embodiments of the invention are directed to cholesteric liquid crystal display devices and driving methods thereof. Orientations of cholesteric liquid crystal molecules are modulated using pressure exerted thereto. The orientations of cholesteric liquid crystal molecules, which depend on capacitance and reflection of the Ch-LCD device, provide dual-stable states of the Ch-LCD device. Furthermore, a capacitance detector is introduced to measure displaying state of each region of the Ch-LCD device such that the Ch-LCD device can exhibit dual mode function of displaying and/or inputting data image.

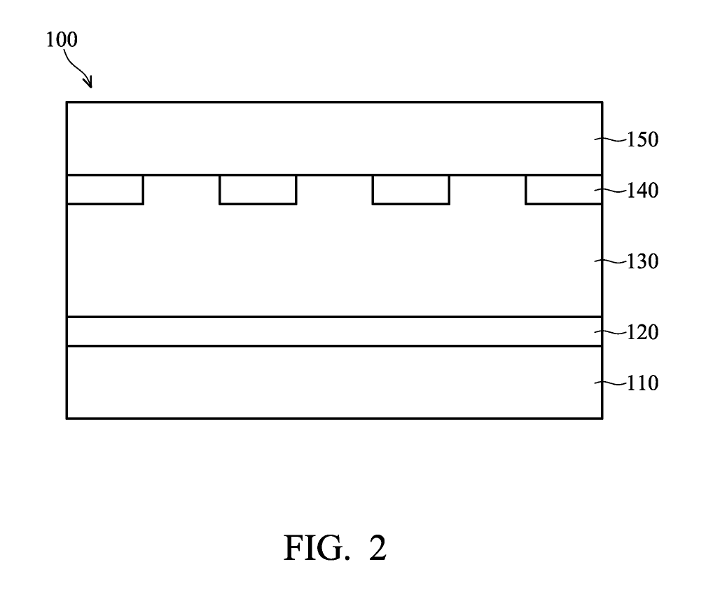

FIG. 2 is a cross section of an exemplary embodiment of the Ch-LCD device. Referring to FIG. 2, a Ch-LCD panel 100 comprises a first substrate 110, a second substrate 150 and a cholesteric liquid crystal layer 130 interposed therebetween. The Ch-LCD panel 100 may further comprise a single displaying region or a plurality of displaying regions, wherein each displaying region of the Ch-LCD panel 100 corresponds to one or more pixels.

The Ch-LCD panel 100 can be a passive matrix cholesteric liquid crystal display panel in which a first electrode 120 along a first direction is disposed on the first substrate 110, and a second electrode 140 along a second direction is disposed on the second substrate 150, wherein the first direction and the second direction are substantially perpendicular to each other.

Alternatively, the Ch-LCD panel 100 can be an active matrix cholesteric liquid crystal display panel with an array of pixels, wherein each pixel of the active matrix cholesteric liquid crystal display panel comprises a thin film transistor and a storage capacitor. The liquid crystal layer 130 is a cholesteric liquid crystal layer with a dual stable displaying state of a planar texture state and a focal conic texture state. Moreover, the liquid crystal layer 130 can alternatively be a twisted nematic liquid crystal layer doped with chiral agent. When the liquid crystal layer 130 sustains a pressure, the orientations of the liquid crystal molecules are transformed from a first displaying state (e.g., a focal conic texture state) to a second displaying state (e.g., a planar texture state). A first capacitance (Cf) of the first displaying state of the liquid crystal layer 130 is substantially different from a second capacitance (Cp) of the second displaying state.

Since the orientations of the cholesteric liquid crystal molecules include dual stable display states, following the renewed displaying image, should the electric source be removed, the image will be maintained. As such, the Ch-LCD panel is suitable for electronic paper or electronic book applications.

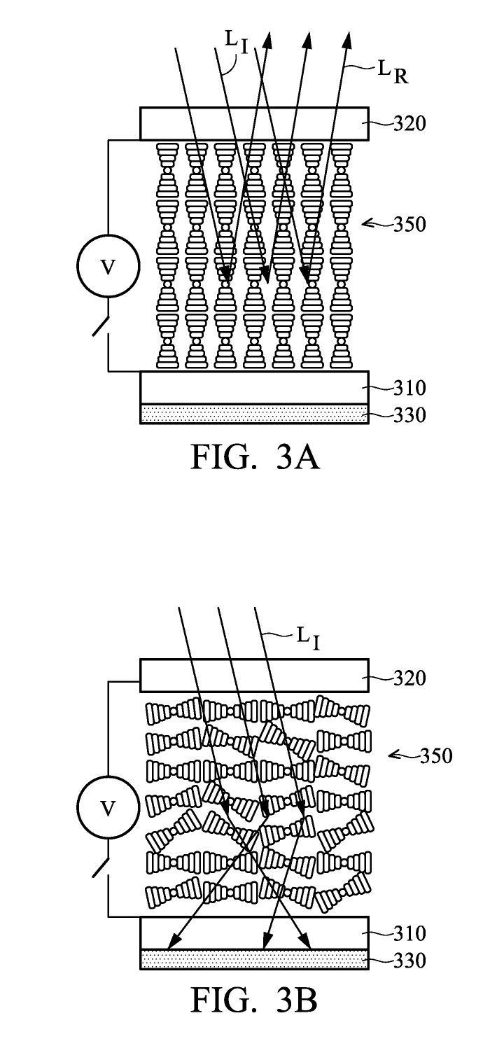

FIG. 3A and FIG. 3B respectively show a planar texture state and a focal conic texture state of the orientations of the cholesteric liquid crystal molecules. Referring to FIGS. 3A and 3B, a Ch-LCD panel comprises an upper substrate 320, a lower substrate 310, an absorption layer 330 disposed on the back of the lower substrate 310, and a liquid crystal layer 350 interposed between the upper and the lower substrates. Since the orientations of the cholesteric liquid crystal molecules include at least dual stable states, at an initially state such as a planar texture state, liquid crystal molecules consistently reflect incident light L_{I} to reflection light L_{R}, thus displaying a bright field image as shown in FIG. 3A. As the applied voltage increases, the orientations of the cholesteric liquid crystal molecules transform to a focal conic texture state. Thus, liquid crystal molecules scatter incident light L_{I} displaying a dark field image as shown in FIG. 3B.

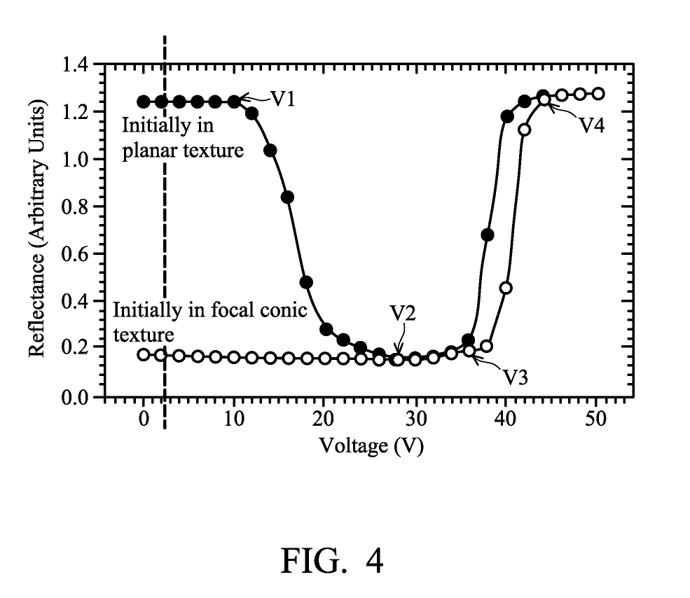

FIG. 4 shows the transformational relationship between a planar texture state and a focal conic texture state following an applied field to the Ch-LCD panel. The initial state of the liquid crystal molecules can be a planar texture state or a focal conic texture state. As applied voltage increases, the orientations of the liquid crystal molecules are transformed from the planar texture state to the focal conic texture state, or transformed from the focal conic texture state to the planar texture state as shown in transformations among voltage V1, V2, V3, and V4 of FIG. 4.

According to an embodiment of the invention, the liquid crystal layer includes a first capacitance (e.g., Cf) at the first displaying state, while the liquid crystal layer includes a second capacitance (e.g., Cp) at the second displaying state. The first capacitance Cf is substantially different from the second capacitance Cp. By measuring capacitance variation between the first capacitance Cf and the second capacitance Cp, the liquid crystal molecule orientations of a specific region of the display under an applied pressure can be determined as accordance for operating the Ch-LCD device.

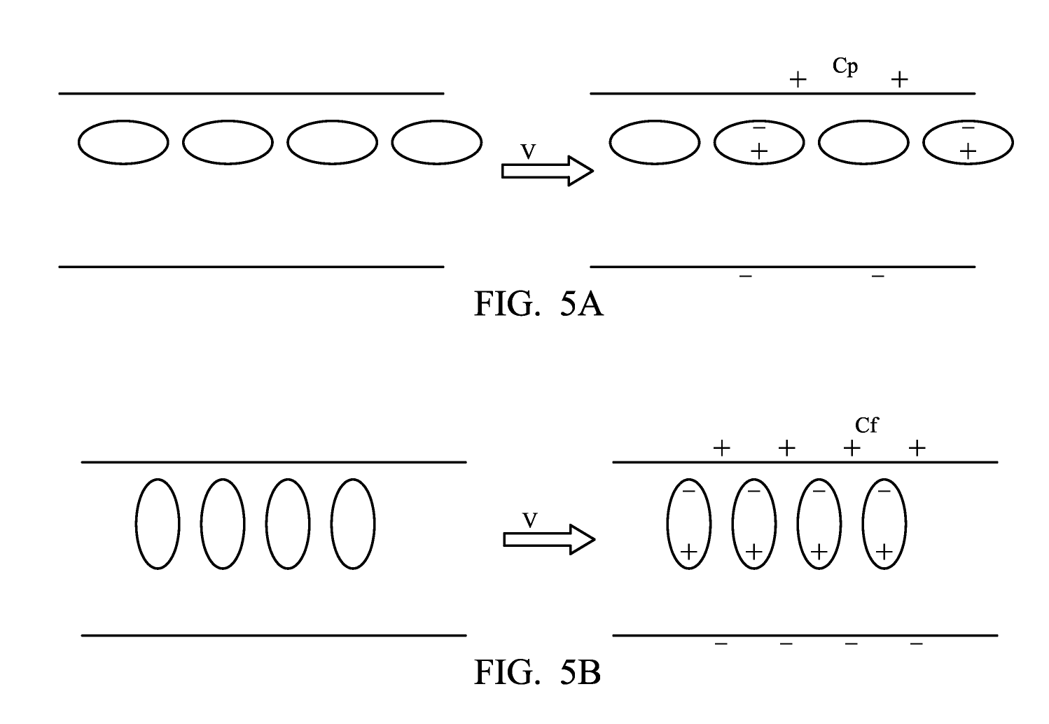

FIG. 5A and FIG. 5B are respectively schematic views illustrating measurement of the capacitances of the planar texture state and the focal conic texture state of the Ch-LCD device. Referring to FIGS. 5A and 5B, a relatively low voltage signal such as 1-5V is provided to measure capacitance of the cholesteric liquid crystal while not causing phase transformation thereof. The voltage signal as provided can cause induced charges on the liquid crystal layer. The induced charges can be measured by a capacitance detector, thereby deciding the first capacitance Cf or the second capacitance Cp, as shown in FIGS. 5A and 5B. According to an embodiment of the invention, the capacitance Cp of the planar texture state is preferably 2.9 nF, and the capacitance Cf of the focal conic texture state is preferably 5.2 nF.

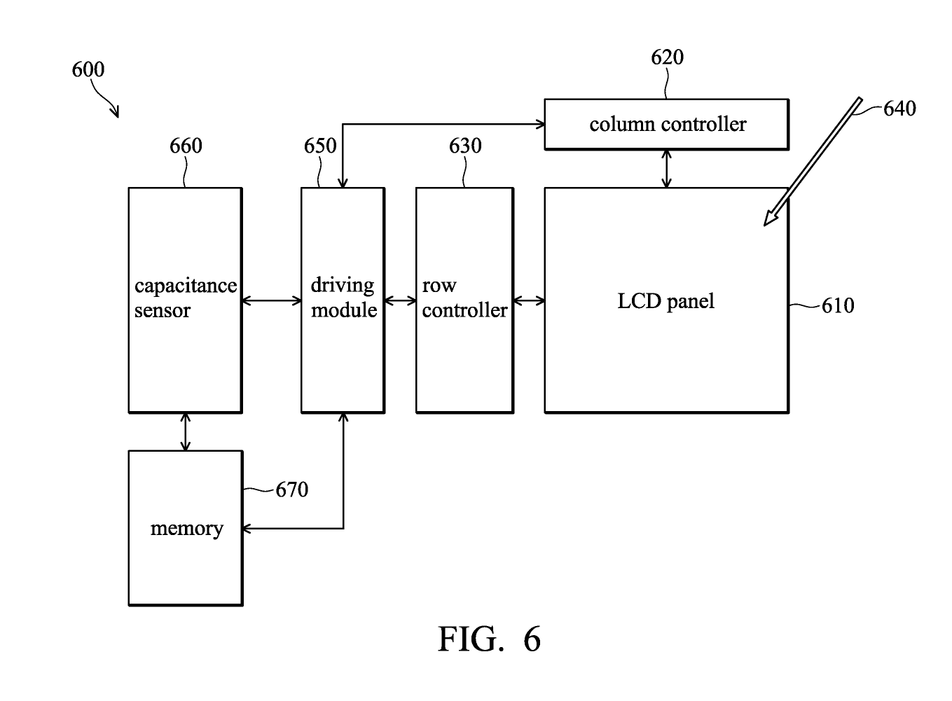

FIG. 6 is a block diagram of an exemplary embodiment of the Ch-LCD device. Referring to FIG. 6, a Ch-LCD device comprises a Ch-LCD panel 610 including a first substrate, a second substrate and a cholesteric liquid crystal layer interposed therebetween, wherein the cholesteric liquid crystal includes at least a first displaying state and a second displaying state, and the first displaying state is substantially different from the second displaying state. An input device 640 applies pressure on the Ch-LCD panel 610 such that the focal conic texture state of the cholesteric liquid crystal is transformed to the planar texture state. The Ch-LCD panel 610 is controlled by a column controller 620 and a row controlled 630 rendering displaying information. A capacitance detector 660 measures the displaying state of the cholesteric liquid crystal layer, stored as a first output signal or second output signal in a memory 670. A driving module 650 provides the Ch-LCD panel a first voltage waveform to renew the cholesteric liquid crystal to the focal conic texture state. According to an embodiment of the invention, the memory 670 is built into the plurality of regions of the Ch-LCD panel 610. Alternatively, the memory 670 is built into the driving module 650 or the capacitance detector 660. Furthermore, the capacitance detector 660 is optionally built into the driving module 650.

Another aspect of the invention provides a driving method for the Ch-LCD device. The Ch-LCD panel can include a single displaying region or a plurality of discrete displaying regions. The optical state of one region is distinguished by measuring the capacitance of it. If the area of the one region is large and/or the number of regions is small, then the effect of parasitic capacitance is insignificant, such that the optical state of the one region can be distinguished by directly measuring the capacitance of it. The capacitance detector corresponds to a driving module, thereby outputting a capacitance sensing voltage waveform from the driving module to the cholesteric liquid crystal display panel such that a capacitance value of the cholesteric liquid crystal layer is acquired and stored in the memory. When the capacitance value falls in a capacitance range of a planar texture state, the capacitance detector outputs a second sensing result, and when the capacitance value falls in a capacitance range of a the focal conic texture state, the capacitance detector outputs a first sensing result.

According to another aspect of the invention, the Ch-LCD panel includes an array of pixels. The optical state of one region is distinguished by measuring the capacitance of it. If the area of the one region is small and/or the number of regions is large, then the effect of parasitic capacitance is significant, such that the optical state of the one region cannot be distinguished by directly measuring the capacitance of it. The capacitance detector corresponds to a driving module. The driving module outputs a capacitance sensing voltage waveform to a first region of the cholesteric liquid crystal display panel such that a first capacitance value corresponding to the first region of the cholesteric liquid crystal layer is acquired and stored in the memory. Sequentially, a first voltage waveform is output from the driving module to the first region rendering displaying of a first displaying state. A capacitance sensing voltage waveform is output from the driving module to the first region such that the capacitance detector detects a second capacitance value from the first region which is stored in the memory. if the first capacitance value equals the second capacitance value, the first region displays the first displaying state initially, and the capacitance detector outputs a first sensing result which is stored in the memory. Alternatively, if the first capacitance value is different from the second capacitance value, the first region displays the second displaying state initially, and the capacitance detector outputs a second sensing result which is stored in the memory, and a second voltage waveform is outputted from the driving module to the first region, thereby rendering the original second displaying state on the first region.

An exemplary driving method for the Ch-LCD device is described as following. A first procedure (e.g., “RESET”) is performed by hand writing to renew displaying image of the display panel. More specifically, using a driving control circuit, a voltage waveform for renewal of displaying image is output to renew each pixel of the display panel as an initial state (state 1). Subsequently, a second procedure (e.g., “WRITE”) is performed by a user to input displaying image information. More specifically, a user can choose any object with a hard tip, such as a finger tip, directly exerting pressure on the display panel. Subsequently, a third procedure (e.g., “SENSE+MEMORY”) is performed detecting the displaying image information and storing it in a memory. More specifically, using a driving control circuit, the displaying state of each pixel of the display panel is detected. The detection method includes outputting a voltage waveform for detecting capacitance of each pixel of the display panel. The voltage waveform can determine the displaying state of a pixel of the display panel in the shortest period. After the displaying state of a pixel is determined, the result is stored in a memory. The display state of each pixel of the display panel is sequentially measured and stored, thus finishing a first page of the displayed image. Repeating the abovementioned “SENSE+MEMORY” procedure, multiple pages of image can be input and stored. The number and size of image pages depend on memory capacity.

Subsequently, a fourth procedure (e.g., “READ”) is performed for a user to review the previous input images. More specifically, using a driving control circuit, a review image is shown on the display panel. If a viewer would like to read one of the previous input images, such as a first image page, a predetermined area corresponding to the first image page on the display panel is selected and pressed, thereby retrieving the first image page from the memory and displaying it on the display panel.

Embodiments of the invention are advantageous in that capacitance change of the cholesteric liquid crystal layer can be measured and stored in a memory, thereby implementing dual mode function of displaying and/or inputting data image on a Ch-LCD device. Since dual mode function of displaying and/or inputting data image can be achieved by a single Ch-LCD panel, the light glaring effect can be inhibited while lowering production costs when compared to current methods. Furthermore, the orientations of liquid crystal molecules can be change by pressure, a user can thus choose any object with a hard tip, such as a finger tip, directly exerting pressure on the display panel to input data. As such, no additional input light source is needed, facilitating input operation and further reducing production costs.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A driving method for a cholesteric liquid crystal display device, comprising:
providing a cholesteric liquid crystal display device comprising:
a cholesteric liquid crystal display panel comprising a first substrate, a second substrate and a cholesteric liquid crystal layer interposed therebetween, wherein the cholesteric liquid crystal includes at least a first displaying state and a second displaying state; and
a capacitance detector measuring the displaying state of the cholesteric liquid crystal layer and storing the measured display state as a first output signal or second output signal in a memory, wherein the capacitance detector corresponds to a driving module;
outputting a capacitance sensing voltage waveform from the driving module to the cholesteric liquid crystal display panel such that a capacitance value of the cholesteric liquid crystal layer is acquired and stored in the memory; and
when the capacitance value falls in a capacitance range of a second displaying state, the capacitance detector outputs a second sensing result, and when the capacitance value falls in a capacitance range of a first displaying state, the capacitance detector outputs a first sensing result.

2. A driving method for a cholesteric liquid crystal display device, comprising:
providing a cholesteric liquid crystal display device comprising:
a cholesteric liquid crystal display panel comprising a first substrate, a second substrate and a cholesteric liquid crystal layer interposed therebetween, wherein the cholesteric liquid crystal includes at least a first displaying state and a second displaying state; and
a capacitance detector measuring the displaying state of the cholesteric liquid crystal layer and storing the measured display state as a first output signal or second output signal in a memory, wherein the capacitance detector corresponds to a driving module; and wherein the driving module outputs a capacitance sensing voltage waveform to the cholesteric liquid crystal display panel such that a first capacitance value corresponding to the cholesteric liquid crystal layer is acquired and stored in the memory;
outputting a first voltage waveform from the driving module to the cholesteric liquid crystal display panel rendering displaying of a first displaying state;
outputting a capacitance sensing voltage waveform from the driving module to the cholesteric liquid crystal display panel such that the capacitance detector detects a second capacitance value from the cholesteric liquid crystal display panel which is stored in the memory;
if the first capacitance value equals the second capacitance value, the cholesteric liquid crystal display panel displays the first displaying state initially, and the capacitance detector outputs a first sensing result which is stored in the memory; and
if the first capacitance value is different from the second capacitance value, the cholesteric liquid crystal display panel displays the second displaying state initially, and the capacitance detector outputs a second sensing result which is stored in the memory, and a second voltage waveform is outputted from the driving module to the cholesteric liquid crystal display panel, thereby rendering the original second displaying state on the cholesteric liquid crystal display panel.

3. A driving method for a cholesteric liquid crystal display device, comprising:
providing a cholesteric liquid crystal display device comprising:
a cholesteric liquid crystal display panel having a plurality of regions, with each region comprising a first substrate, a second substrate and a cholesteric liquid crystal layer interposed therebetween, wherein the cholesteric liquid crystal includes at least a first displaying state and a second displaying state; and
a capacitance detector measuring the displaying state of each region of the cholesteric liquid crystal layer and storing the measured display state as a first output signal or second output signal in a memory, and
a driving module providing the cholesteric liquid crystal display panel a capacitance sensing voltage waveform to acquire capacitance of the cholesteric liquid crystal layer, wherein each region of the cholesteric liquid crystal display panel corresponds to one or more pixels and the capacitance detector corresponds to the driving module;
outputting a capacitance sensing voltage waveform from the driving module to a first region of the cholesteric liquid crystal display panel such that a capacitance value corresponding to the first region of the cholesteric liquid crystal layer is acquired and stored in the memory; and
when the capacitance value falls in a capacitance range of a second displaying state, the capacitance detector outputs a second sensing result, and when the capacitance value falls in a capacitance range of a first displaying state, the capacitance detector outputs a first sensing result.

4. A driving method for a cholesteric liquid crystal display device, comprising:
providing a cholesteric liquid crystal display device comprising:
a cholesteric liquid crystal display panel having a plurality of regions, with each region comprising a first substrate, a second substrate and a cholesteric liquid crystal layer interposed therebetween, wherein the cholesteric liquid crystal includes at least a first displaying state and a second displaying state; and
a capacitance detector measuring the displaying state of each region of the cholesteric liquid crystal layer and storing the measured display state as a first output signal or second output signal in a memory, wherein the capacitance detector corresponds to a driving module, and
a driving module providing the cholesteric liquid crystal display panel a capacitance sensing voltage waveform to acquire capacitance of the cholesteric liquid crystal layer, wherein each region of the cholesteric liquid crystal display panel corresponds to one or more pixels and wherein the capacitance detector corresponds to a driving module, and the driving module outputs a capacitance sensing voltage waveform to a first region of the cholesteric liquid crystal display panel such that a first capacitance value corresponding to the first region of the cholesteric liquid crystal layer is acquired and stored in the memory;
outputting a first voltage waveform from the driving module to the first region rendering displaying of a first displaying state;
outputting a capacitance sensing voltage waveform from the driving module to the first region such that the capacitance detector detects a second capacitance value from the first region which is stored in the memory;
if the first capacitance value equals the second capacitance value, the first region displays the first displaying state initially, and the capacitance detector outputs a first sensing result which is stored in the memory; and
if the first capacitance value is different from the second capacitance value, the first region displays the second displaying state initially, and the capacitance detector outputs a second sensing result which is stored in the memory, and a second voltage waveform is outputted from the driving module to the first region, thereby rendering the original second displaying state on the first region.

5. A driving method for a cholesteric liquid crystal display device, comprising:
providing a cholesteric liquid crystal display device comprising:
a cholesteric liquid crystal display panel having a plurality of regions, with each region comprising a first substrate, a second substrate and a cholesteric liquid crystal layer interposed therebetween, wherein the cholesteric liquid crystal includes at least a first displaying state and a second displaying state;
a driving module rendering each region of the cholesteric liquid crystal display panel to display a first displaying state and a second displaying state; and
a capacitance detector measuring the displaying state of each region of the cholesteric liquid crystal layer and storing the measured display state as a first output signal or second output signal in a memory;
outputting a capacitance sensing voltage waveform from the driving module to a first region of the cholesteric liquid crystal display panel such that a capacitance value corresponding to the first region of the cholesteric liquid crystal layer is acquired and stored in the memory; and
when the capacitance value falls in a capacitance range of a second displaying state, the capacitance detector outputs a second sensing result, and when the capacitance value falls in a capacitance range of a first displaying state, the capacitance detector outputs a first sensing result.

6. A driving method for a cholesteric liquid crystal display device, comprising:
providing a cholesteric liquid crystal display device comprising:
a cholesteric liquid crystal display panel having a plurality of regions, with each region comprising a first substrate, a second substrate and a cholesteric liquid crystal layer interposed therebetween, wherein the cholesteric liquid crystal includes at least a first displaying state and a second displaying state;
a driving module rendering each region of the cholesteric liquid crystal display panel to display a first displaying state and a second displaying state; and
a capacitance detector measuring the displaying state of each region of the cholesteric liquid crystal layer and storing the measured display state as a first output signal or second output signal in a memory, wherein the driving module outputs a capacitance sensing voltage waveform to a first region of the cholesteric liquid crystal display panel such that a first capacitance value corresponding to the first region of the cholesteric liquid crystal layer is acquired and stored in the memory;
outputting a first voltage waveform from the driving module to the first region rendering displaying of a first displaying state;
outputting a capacitance sensing voltage waveform from the driving module to the first region such that the capacitance detector detects a second capacitance value from the first region which is stored in the memory;
if the first capacitance value equals the second capacitance value, the first region displays the first displaying state initially, and the capacitance detector outputs a first sensing result which is stored in the memory; and
if the first capacitance value is different from the second capacitance value, the first region displays the second displaying state initially, and the capacitance detector outputs a second sensing result which is stored in the memory, and a second voltage waveform is outputted from the driving module to the first region, thereby rendering the original second displaying state on the first region.
